(19) United States
(12) Patent Application Publication
(10) Pub. No.: US 2020/0167847 A1
(43) Pub. Date: May 28, 2020

(54) MATERIAL DISPLAY CONTROL METHOD, DEVICE AND SYSTEM

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Zixiong ZHOU, Beijing (CN); Jinliang SUN, Beijing (CN); Linbo ZHU, Beijing (CN); Xing YAO, Beijing (CN); Xiaoman WANG, Beijing (CN); Qihui HUANG, Beijing (CN); Tianzhi WANG, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/630,733

(22) PCT Filed: Jul. 10, 2018
(86) PCT No.: PCT/CN2018/095170

§ 371 Date: Jan. 13, 2020

(30) Foreign Application Priority Data
Jul. 13, 2017 (CN) 201710567863.0

(51) Int. Cl. G06Q 30/06; G06F 16/9538; G06F 16/2457; G06F 16/9535

(52) U.S. Cl. CPC G06Q 30/0631; G06F 16/9535; G06F 16/24578; G06F 16/9538

(57) ABSTRACT

The disclosure provides a material display control method, device and system, and relates to the field of information processing. The control device extracts a user identification of a client from an access request sent by the client, extracts a commodity material corresponding to the number of times of historical accesses associated with the user identification from a recommendation list associated with the user identification, wherein the commodity materials in the recommendation list are sorted according to the user's preference, and deliver the extracted commodity material to the client for displaying.

### CROSS-REFERENCE TO RELATED APPLICATIONS

The present application is a U.S. National Stage Application under 35 U.S.C. § 371 of International Patent Application No. PCT/CN2018/095170, filed on Jul. 10, 2018 which claims priority of China Patent Application No. 201710567863.0 filed on Jul. 13, 2017, the disclosure of both of which are incorporated by reference hereby in entirety into the present application.

### TECHNICAL FIELD

The present disclosure relates to the field of information processing, and in particular, to a control method, an control apparatus, and a control system for displaying material.

### BACKGROUND

Massive commodity materials are sorted according to a personal preference of a user, so that the commodity materials most preferred by the user are displayed to the user, and the purchase conversion efficiency of the user after viewing the commodity materials can be effectively improved.

### SUMMARY

According to a first aspect of an embodiment of the present disclosure, there is provided a control method for displaying material, including: extracting a user identification of a client from an access request sent by the client; extracting a commodity material corresponding to the number of times of historical accesses associated with the user identification from a recommendation list associated with the user identification, wherein the commodity materials in the recommendation list are sorted according to the user's preference; and delivering the extracted commodity material to the client for displaying in a page window.

In some embodiments, the control method further includes after extracting the user identification: judging whether the access request is a first access request sent by the client according to the user identification; generating the recommendation list associated with the user identification under the condition that the access request is the first access request sent by the client.

In some embodiments, the control method further includes judging whether a time interval between the access request and a previous access request exceeds a preset interval threshold; updating the recommendation list under the condition that the time interval exceeds a preset interval threshold; clearing the number of times of the historical accesses.

In some embodiments, the extracting the commodity material includes: adding 1 to the number of times of historical accesses to obtain a list index; extracting the commodity material corresponding to the list index from the recommendation list.

In some embodiments, the recommendation list comprises multiple recommendation sub-lists, the page window comprises multiple page sub-windows, the recommendation sub-lists corresponds to the page sub-windows one to one; wherein the extracting the commodity material comprises: extracting commodity materials from the recommendation sub-lists associated with the user identification.

In some embodiments, after extracting the commodity materials: judging whether any two materials are similar according to the similarity between the two similar materials, wherein the two materials are similar under the condition that the similarity between the two materials is greater than a preset similarity threshold; replacing one material of two similar materials with a next commodity material in the recommendation sub-list corresponding to the one material under the condition that the two materials are similar, to ensure that the extracted commodity materials are not similar.

In some embodiments, further including: updating the number of times of historical accesses, and delivering the updated number of times of historical accesses to the client.

In some embodiments, after updating the number of times of historical accesses: judging whether the updated number of times of historical accesses is less than a preset times threshold; clearing the number of times of historical accesses under the condition that the updated number of times of historical accesses is not less than a preset times threshold, and delivering the cleared number of times of historical accesses to the client.

According to a second aspect of an embodiment of the present disclosure, there is provided a control method for displaying material, including: a memory; and a processor coupled to the memory, the processor being configured to: extract a user identification of a client from an access request sent by the client; extract a commodity material corresponding to the number of times of historical accesses associated with the user identification from a recommendation list associated with the user identification, wherein the commodity materials in the recommendation list are sorted according to the user's preference; and deliver the extracted commodity material to the client for displaying in a page window.

In some embodiments, the processor is configured to: judge whether the access request is a first access request sent by the client according to the user identification after extracting the user identification; generate the recommendation list associated with the user identification under the condition that the access request is the first access request sent by the client.

In some embodiments, the processor is configured to: judge whether a time interval between the access request and a previous access request exceeds a preset interval threshold; update the recommendation list under the condition that the time interval exceeds a preset interval threshold; clear the number of times of the historical accesses.

In some embodiments, the processor is configured to: add 1 to the number of times of historical accesses to obtain a list index; extract the commodity material corresponding to the list index from the recommendation list.

In some embodiments, the recommendation list comprises multiple recommendation sub-lists, the page window comprises multiple page sub-windows, the recommendation sub-lists corresponds to the page sub-windows one to one; the processor is configured to: extract commodity materials from the recommendation sub-lists associated with the user identification.

In some embodiments, the processor is configured to: judge whether any two materials are similar according to the similarity between the two similar materials after extracting the commodity materials, wherein the two materials are similar under the condition that the similarity between the two materials is greater than a preset similarity threshold; replace one material of two similar materials with a next commodity material in the recommendation sub-list corresponding to the one material under the condition that the two materials are similar, to ensure that the extracted commodity materials are not similar.

In some embodiments, the processor is configured to: update the number of times of historical accesses, and deliver the updated number of times of historical accesses to the client.

In some embodiments, the processor is configured to: judge whether the updated number of times of historical accesses is less than a preset times threshold after updating the number of times of historical accesses; clear the number of times of historical accesses under the condition that the updated number of times of historical accesses is not less than a preset times threshold, and delivering the cleared number of times of historical accesses to the client.

According to a third aspect of an embodiment of the present disclosure, there is provided a control method for displaying material, including: a control device for displaying the material according to any of the above embodiments; a client configured to send an access request to the control device, wherein the access request comprises a user identification, and configured to receive commodity material delivered by the control device, to display the commodity material in a page window.

In some embodiments, the client is also configured to receive information of the number of times of historical accesses delivered by the control device as the current number of times of historical accesses.

According to a fourth aspect of an embodiment of the present disclosure, there is provided a non-transitory computer readable storage medium, wherein the computer readable storage medium stores computer instructions which, when executed by a processor on a computing device, cause the computing device to: extract a user identification of a client from an access request sent by the client;

extract a commodity material corresponding to the number of times of historical accesses associated with the user identification from a recommendation list associated with the user identification, wherein the commodity materials in the recommendation list are sorted according to the user's preference; and deliver the extracted commodity material to the client for displaying in a page window.

Other features of the present disclosure and advantages thereof will become apparent from the following detailed description of exemplary embodiments thereof, which proceeds with reference to the accompanying drawings.

### BRIEF DESCRIPTION OF THE DRAWINGS

In order to more clearly illustrate the embodiments of the present disclosure or the technical solutions in the prior art, the drawings used in the embodiments or the description of the prior art will be briefly described below, it is obvious that the drawings in the following description are only some embodiments of the present disclosure, and for those skilled in the art, other drawings may be obtained according to the drawings without inventive efforts.

FIG. 1 is an exemplary flowchart illustrating a control method for displaying material according to one embodiment of the present disclosure;

FIG. 2 is an exemplary flow chart illustrating a control method for displaying material according to another embodiment of the present disclosure;

FIG. 3 is an exemplary flow chart illustrating a control method for displaying material according to still another embodiment of the present disclosure;

FIG. 4 is an exemplary flow chart illustrating a control method for displaying material according to still another embodiment of the present disclosure;

FIG. 5 is an exemplary flow chart illustrating a control method for displaying material according to still another embodiment of the present disclosure;

FIG. 6 is an exemplary block diagram illustrating a control device for displaying material according to one embodiment of the present disclosure;

FIG. 7 is an exemplary block diagram illustrating a control device for displaying material according to another embodiment of the present disclosure;

FIG. 8 is an exemplary block diagram illustrating a control device for displaying material according to still another embodiment of the present disclosure;

FIG. 9 is an exemplary block diagram illustrating a control device for displaying material according to still another embodiment of the present disclosure;

FIG. 10 is an exemplary block diagram illustrating a control system for displaying material according to one embodiment of the present disclosure.

### DETAILED DESCRIPTION

The technical solutions in the embodiments of the present disclosure will be described clearly and completely with reference to the drawings in the embodiments of the present disclosure, and it is obvious that the embodiments described are only part, instead of all, of the embodiments of the present disclosure. The following description of at least one exemplary embodiment is merely illustrative in nature and is in no way intended to limit the disclosure, its application, or uses. All other embodiments, which can be derived by a person skilled in the art from the embodiments disclosed herein without paying inventive effort, belong to the scope of protection of the present disclosure.

The relative arrangement of parts and steps, numerical expressions and numerical values set forth in these embodiments do not limit the scope of the present disclosure unless specifically stated otherwise.

Meanwhile, it should be understood that the sizes of the respective portions shown in the drawings are not drawn in an actual proportional relationship for the convenience of description.

Techniques, methods, and apparatus known to one of ordinary skill in the relevant art may not be discussed in detail but should be taken as part of the specification where appropriate.

In all examples shown and discussed herein, any particular value should be construed as exemplary only and not as limiting. Thus, other examples of the exemplary embodiments may have different values.

It should be noted that similar reference numbers and letters refer to similar like items in the following figures, and thus, once an item is defined in one figure, it need not be discussed further in subsequent figures.

The inventors have realized that since the recommendation result is only one commodity material that is preferred by the user, the recommended content lacks changes and does not provide a good browsing experience.

For this reason, the present disclosure provides a solution capable of providing a good browsing experience.

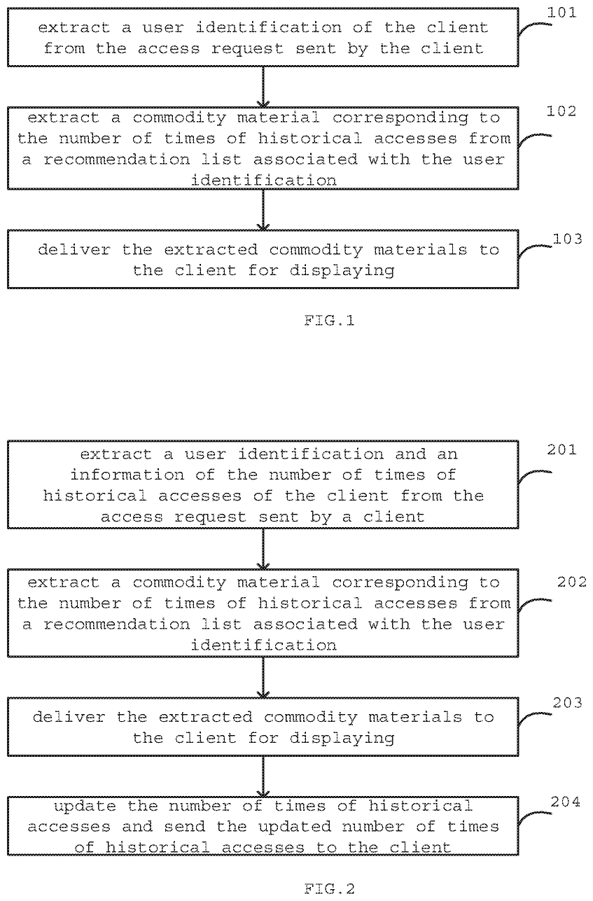

FIG. 1 is an exemplary flowchart illustrating a control method for displaying material according to one embodiment of the present disclosure. In some embodiments, the method steps of the present embodiment may be performed by a control device for displaying material.

In step 101, a user identification of a client is extracted from the access request sent by the client.

In step 102, a commodity material corresponding to the number of times of historical accesses associated with the user identification is extracted from a recommendation list associated with the user identification.

The commodity materials in the recommendation list are sorted according to the user's preference.

In some embodiments, the number of times of historical accesses corresponding to the user identification is stored in the control device for displaying material. In other embodiments, the number of times of historical accesses may be stored in the client. When the client sends an access request, the number of times of historical accesses is carried in the access request.

In some embodiments, the number of times of historical accesses may be added by 1 to obtain a list index, and a corresponding commodity material may be extracted from a recommendation list according to the list index.

For example, if the number of times of historical accesses is 0, the obtained list index is 1, that is, the commodity material ranked at the top of the corresponding recommendation list is recommended to the user. If the number of times of historical accesses is 1, the obtained list index is 2, that is, the commodity material ranked at the second position in the corresponding recommendation list is recommended to the user. Therefore, the recommended commodity material is ensured to be interesting to the user. In addition, certain changes of the page can be ensured, and the good browsing experience is guaranteed.

In some embodiments, the recommendation list comprises multiple recommendation sub-lists, and the page window comprises multiple page sub-windows, the recommendation sub-lists corresponds to the page sub-windows one to one. That is, each sub-window on the client page has a corresponding recommendation sub-list. For example, if there are three sub-windows on the client's page, then each sub-window will have a corresponding recommendation sub-list. When the user refreshes the client page, each sub-window on the client page respectively presents the commodity materials extracted from the corresponding recommendation sub-list.

In step 103, the extracted commodity material is delivered to the client for displaying in a page window.

According to the control method for displaying material provided by the embodiments of the disclosure, the commodity materials are arranged in a descending order according to the preference of the user in the recommendation list associated with the user, and then the commodity materials are sequentially extracted from the corresponding recommendation list according to the number of times of historical accesses of the user, such that the commodity materials preferred by the user are provided for the user, and the good browsing experience can be obtained.

FIG. 2 is an exemplary flow chart illustrating a control method for displaying material according to another embodiment of the present disclosure. In some embodiments, the method steps of the present embodiment may be performed by a control device for displaying material.

In step 201, a user identification and an information of the number of times of historical accesses of the client are extracted from the access request sent by the client.

In step 202, a commodity material corresponding to the number of times of historical accesses associated with the user identification is extracted from a recommendation list associated with the user identification.

In step 203, the extracted commodity material is delivered to the client for displaying in a page window.

In step 204, the number of times of historical accesses is updated, and the updated number of times of historical accesses is sent to the client.

For example, when a user accesses for the first time, the number of times of historical accesses is 0. After the commodity material ranked at the first place in the corresponding recommendation list is extracted, the historical accesses data is updated, that is, 0+1=1, and the updated number of times of historical accesses is returned to the client, so that the client obtains the commodity material ranked at the second place in the corresponding recommendation list using the updated number of times of historical accesses at the next access.

It should be noted that if the number of times of access of the user is too large, and low ranking commodity materials are not good for purchase conversion, the number of times of historical accesses can be forced to zero. Therefore the commodity material ranked at the first place in the corresponding recommendation list is delivered to the user at the next access.

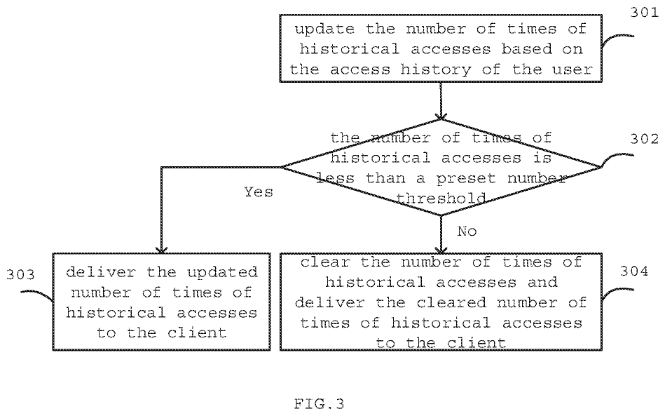

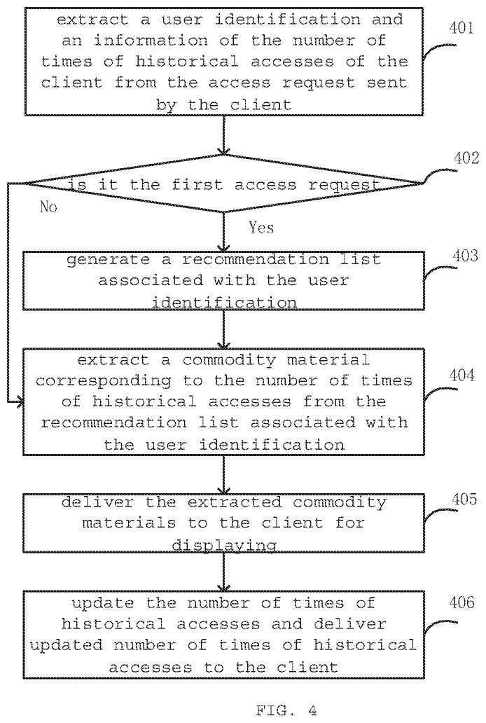

FIG. 3 is an exemplary flowchart illustrating a control method for displaying material according to still another embodiment of the present disclosure. In some embodiments, the method steps of the present embodiment may be performed by a control device for displaying material.

In step 301, the number of times of historical accesses is updated based on the access history of the user.

In step 302, it is determined whether the updated number of times of historical accesses is less than a preset number threshold. If the updated number of times of historical accesses is less than the preset times threshold, step 303 is performed; if the updated number of times of historical accesses is not less than the preset number threshold, step 304 is performed.

In step 303, the updated number of times of historical accesses is sent to the client.

In step 304, the number of times of historical accesses is cleared, and the cleared number of times of historical accesses is sent to the client.

For example, if the updated number of times of historical accesses reaches 100, the 101st item material in the recommendation list is obtained when the user accesses next time. Since the user's attention to the 101st commodity material is relatively small, displaying the 101st commodity material is not good for conversion of the purchase. Therefore, the number of times of historical accesses is forcedly cleared, so that the commodity material ranked the first place in the recommendation list can be obtained when the user accesses the recommendation list next time, and the commodity materials preferred by the user can be provided to the user.

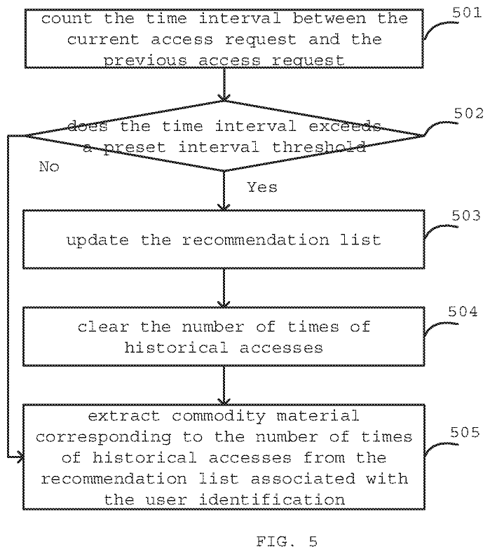

FIG. 4 is an exemplary flowchart illustrating a control method for displaying material according to still another embodiment of the present disclosure. In some embodiments, the method steps of the present embodiment may be performed by a control device for display material.

In step 401, a user identification and an information of the number of times of historical accesses of the client are extracted from the access request sent by the client.

In step 402, it is determined whether the access request is a first access request sent by the client according to the user identification. If the access request is the first access request sent by the client, step 403 is performed; if the access request is not the first access request sent by the client, step 404 is performed.

In step 403, a recommendation list associated with the user identification is generated.

In step 404, a commodity material corresponding to the number of times of historical accesses is extracted from the recommendation list associated with the user identification.

In step 405, the extracted commodity materials are sent to the client for presentation.

In step 406, the number of times of historical accesses is updated, and the updated number of times of historical accesses is delivered to the client.

It should be noted here that, if the interval between two adjacent accesses of the user is too long, it is likely that the result of the personalized ranking has changed. At this time, the recommendation list should be updated, so as to provide more accurate recommendation of the commodity material.

FIG. 5 is an exemplary flowchart illustrating a control method for displaying material according to still another embodiment of the present disclosure. In some embodiments, after the above step 402 determines that the access request is not the first access request sent by the client, the following steps are further performed.

In step 501, a time interval between a current access request and a previous access request is counted.

In step 502, it is determined whether the time interval exceeds a preset interval threshold. If the time interval exceeds the preset interval threshold, step 503 is performed; if the time interval does not exceed the preset interval threshold, step 505 is performed.

In step 503, the recommendation list associated with the user identification is updated.

In step 504, the number of times of historical accesses is cleared.

In step 505, commodity material corresponding to the number of times of historical accesses is extracted from the recommendation list associated with the user identification.

For example, if the time interval is less than 10 minutes, the original recommendation list is still used. If the time interval reaches or exceeds 10 minutes, the recommendation list of the user may have changed, so that the recommendation list needs to be updated and the historical accesses times are cleared, so that the commodity materials in the first order in the regenerated recommendation list can be accessed.

In some embodiments, the recommendation list comprises multiple recommendation sub-lists, the page window comprises multiple page sub-windows, the recommendation sub-lists corresponds to the page sub-windows one to one. For example, if there are three sub-windows on the page, three different recommendation sub-lists A, B and C are generated accordingly. For example, when a user accesses for the first time, the materials a1, b1 and c1 ranked at the top of the corresponding recommendation sub-lists A, B and C can be extracted, respectively. And the materials a1, b1 and c1 are delivered to the client for displaying.

In this process, if the materials a1 and b1 are similar (determined according to the categories and patterns of commodities), this will result in waste of resources and reduce the efficiency of conversion of purchase. The two materials are similar under the condition that the similarity between the two materials is greater than a preset similarity threshold. For this reason, the material b1 may be replaced by the material b2 after the material b1 in the recommendation sub-list B. The materials a1, b2 and c1 are delivered to the client for displaying, thereby providing the user with different materials as much as possible to improve the purchase conversion efficiency.

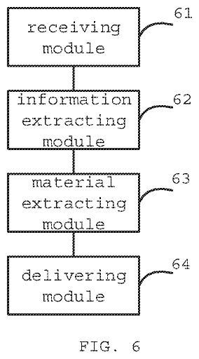

FIG. 6 is an exemplary block diagram illustrating a control device for display material according to one embodiment of the present disclosure. As shown in FIG. 6, the control device includes a receiving module 61, an information extracting module 62, a material extracting module 63, and a delivering module 64.

The receiving module 61 is configured to receive an access request sent by a client.

The information extracting module 62 is configured to extract a user identification of the client from the access request after the receiving module 61 receives the access request sent by the client.

The material extracting module 63 is configured to extract a commodity material corresponding to the number of times of historical accesses associated with the user identification from a recommendation list associated with the user identification. In the recommendation list, the commodity materials are arranged in a descending order according to user preference.

In some embodiments, the number of times of historical accesses corresponding to the user identification is stored in the control device for displaying material. In other embodiments, the number of times of historical accesses may be stored at the client. When the client sends the access request, the number of times of historical accesses is carried in the access request.

In some embodiments, the material extracting module 63 is configured to add 1 to the number of times of historical accesses to obtain a list index, and extract the commodity material corresponding to the list index from the recommendation list.

In some embodiments, the recommendation list comprises multiple recommendation sub-lists, the page window comprises multiple page sub-windows, the recommendation sub-lists corresponds to the page sub-windows one to one. In this case, the material extracting module 63 is configured to extract commodity materials from the recommendation sub-lists associated with the user identification.

The delivering module 64 is configured to deliver the extracted commodity material to the client for displaying.

According to the control device for displaying material provided by the embodiment of the disclosure, the commodity materials are arranged a descending order in the recommendation list according to user preference. The commodity materials are sequentially extracted from the corresponding recommendation list according to the number of times of historical accesses of the user. Therefore he commodity materials preferred by the user are provided for the user, and the good browsing experience can be obtained.

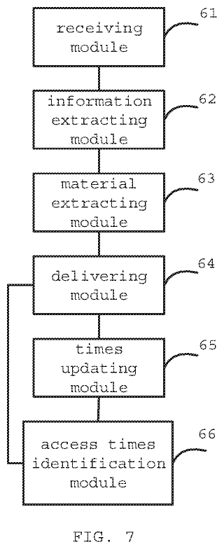

FIG. 7 is an exemplary block diagram illustrating a control device for displaying material according to another embodiment of the present disclosure. FIG. 7 is different from FIG. 6 in that, in the embodiment shown in FIG. 7, the control device for displaying material further includes a times updating module 65.

The times updating module 65 is configured to update the number of times of historical accesses and instruct the delivering module 64 to deliver the updated number of times of historical accesses to the client.

In some embodiments, in the embodiment shown in FIG. 7, an access times identification module 66 is further included. The access times identification module 66 is configured to judge whether the updated number of times of historical accesses is less than a preset number threshold after the historical accesses number is updated by the times updating module 65. If the updated number of times of historical accesses is less than the preset times threshold, the access times identification module 66 instructs the delivering module to execute an operation of delivering the updated number of times of historical accesses to the client.

In some embodiments, the access times identification module 66 is further configured to clear the number of times of historical accesses and instruct the delivering module 64 to deliver the cleared the number of times of historical accesses to the client under the condition that the updated number of times of historical accesses is not less than the preset times threshold.

By forcibly clearing the number of times of historical access, the materials with low user preference degree can be prevented from being provided to the user.

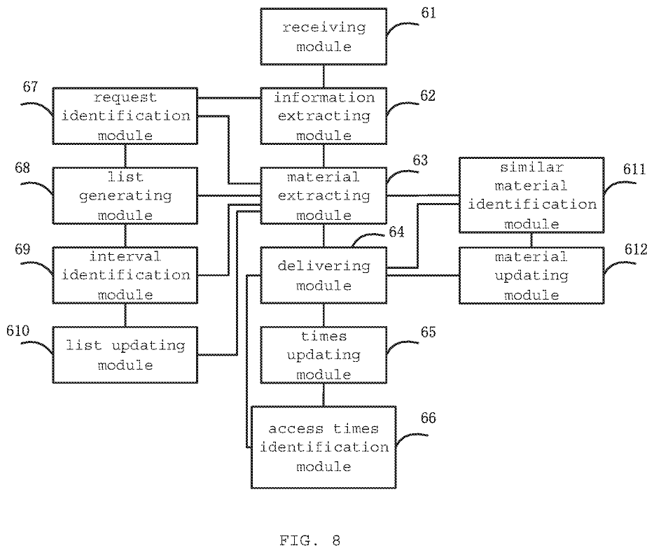

FIG. 8 is an exemplary block diagram illustrating a control device for displaying material according to still another embodiment of the present disclosure. FIG. 8 is different from FIG. 7 in that, in the embodiment shown in FIG. 8, the control device for displaying material further includes a request identification module 67 and a list generation module 68.

The request identification module 67 is configured to, after the information extraction module 62 extracts the user identification of the client from the access request, judge whether the access request is a first access request sent by the client according to the user identification.

The list generating module 68 is configured to generate a recommendation list associated with the user identifier under the condition that the access request is the first access request sent by the client. The list generating module 68 is configured to instruct the material extraction module 63 to perform an operation of extracting the commodity material from the personalized recommendation list associated with the user identification according to the number of times of historical accesses.

In some embodiments, the request identification module 67 is further configured to instruct the material extraction module 63 to perform an operation of extracting material from the recommendation list associated with the user identifier according to the number of times of historical accesses under the condition that the access request is not the first access request sent by the client.

In some embodiments, as shown in FIG. 8, the control device for displaying material further includes an interval identification module 69 and a list updating module 610.

The interval identification module 69 is configured to, under the condition that a access request is not the first access request sent by the client, judge whether a time interval between the access request and a previous access request exceeds a preset interval threshold. If the time interval does not exceed the preset interval threshold, The interval identification module 69 is configured to instruct the material extraction module 63 to perform an operation of extracting commodity material from the recommendation list associated with the user identification according to the number of times of historical accesses.

The list updating module 610 is configured to regenerate a recommendation list associated with the user identification under the condition that the time interval exceeds the preset interval threshold, clear the number of times of historical accesses, and instruct the material extracting module 63 to perform an operation of extracting the commodity material from the recommendation list associated with the user identification according to the number of times of historical accesses.

In some embodiments, as shown in FIG. 8, the control device for displaying material further includes a similar material identification module 611 and a material updating module 612.

The similar material identification module 611 is configured to judge whether any two materials are similar according to the similarity between the two similar materials, wherein the two materials are similar under the condition that the similarity between the two materials is greater than a preset similarity threshold. If the similar materials do not exist, the similar material identification module 611 is configured to instruct the delivering module 64 to execute the operation of delivering the extracted commodity materials to the client.

Under the condition that the two materials are similar, the material updating module 612 is configured to replace one material of two similar materials with a next commodity material in the recommendation sub-list corresponding to the one material, so that the extracted commodity materials are not similar. The material updating module 612 is configured to instruct the delivering module 64 to perform an operation of delivering the extracted commodity materials to the client.

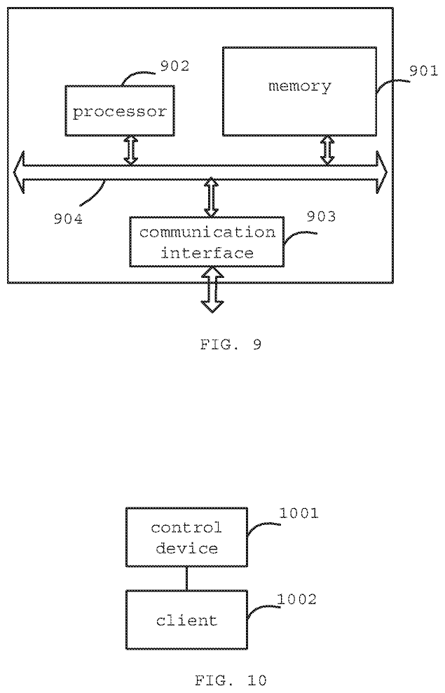

FIG. 9 is an exemplary block diagram illustrating a control device for displaying material according to still another embodiment of the present disclosure. As shown in FIG. 9, the control device for displaying material includes a memory 901 and a processor 902.

The memory 901 is used for storing instructions, the processor 902 is coupled to the memory 901. The processor 902 is configured to execute the method according to any of the embodiments in FIGS. 1 to 5 based on the instructions stored in the memory.

As shown in FIG. 9, the control device further includes a communication interface 903 for information interaction with other devices. Meanwhile, the control device also comprises a bus 904. The processor 902, the communication interface 903 and the memory 901 communicated with each other through the bus 904.

Memory 901 may comprise high-speed RAM memory, and may also include non-volatile memory (non-volatile memory), such as at least one disk memory. Memory 901 may also be a memory array. The memory 901 may also be partitioned, and the blocks may be combined into virtual volumes according to certain rules.

Further, the processor 902 may be a central processing unit CPU, or may be an Application Specific Integrated Circuit (ASIC), or one or more integrated circuits configured to implement embodiments of the present disclosure.

FIG. 10 is an exemplary block diagram illustrating a control system for displaying material according to one embodiment of the present disclosure. As shown in FIG. 10, the control system for displaying material includes a control device 1001 and a client 1002. The control device 1001 is a control device for displaying material according to any one of FIGS. 6 to 9.

The client 1002 is configured to send an access request to the control device 1001, wherein the access request includes a user identification. The client 1002 is further configured to receive commodity material sent by the control device 1001, so as to display the commodity material in a corresponding page window.

In some embodiments, the access request sent by the client 1002 also carries corresponding information of the number of times of historical access.

In some embodiments, the client 1002 is further configured to receive the information of the number of times of historical accesses delivered by the control device 1001 as the current number of times of historical accesses.

For example, when the client sends an access request for the first time, the number of times of historical accesses is 0. When the user refreshes the page, the client sends an access request so as to obtain the corresponding personalized commodity material.

In some embodiments, the functional unit modules described in the above embodiments may be implemented as a general purpose Processor, a Programmable Logic Controller (PLC), a Digital Signal Processor (DSP), an Application Specific Integrated Circuit (ASIC), a Field Programmable Gate Array (FPGA) or other programmable logic devices, discrete gate or transistor logic device, discrete hardware components, or any suitable combination thereof for performing the functions described in the present disclosure.

The present disclosure also provides a computer-readable storage medium, where the computer-readable storage medium stores computer instructions, and when the computer instructions are executed by a processor, the computer-readable storage medium implements a material presentation control method related to any one of FIGS. 1 to 5. As will be appreciated by those skilled in the art, embodiments of the present disclosure may be provided as a method, apparatus, or computer program product. Accordingly, the present disclosure may take the form of an entirely hardware embodiment, an entirely software embodiment or an embodiment combining software and hardware aspects. Furthermore, the present disclosure may take the form of a computer program product embodied on one or more computer-usable non-transitory storage media (including, but not limited to, disk storage, CD-ROM, optical storage, and so forth) having computer-usable program code embodied therein.

Through testing, the flow conversion rate of the window using the materials can be improved by more than 50%.

As will be appreciated by one of skill in the art, embodiments of the present disclosure may be provided as a method, system, or computer program product. Accordingly, the present disclosure may take the form of an entirely hardware embodiment, an entirely software embodiment or an embodiment combining software and hardware aspects. Furthermore, the present disclosure may take the form of a computer program product embodied on one or more computer-usable non-transitory storage media (including, but not limited to, disk storage, CD-ROM, optical storage, and so forth) having computer-usable program code embodied therein.

The present disclosure is described with reference to flowchart and/or block diagrams of methods, devices (systems), and computer program products according to embodiments of the disclosure. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing apparatus to generate a machine, such that the instructions, which is executed via the processor of the computer or other programmable data processing apparatuses, generate means for implementing the functions specified in one or more flows of the flowchart and/or one or more blocks in the block diagram.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in one or more flows in the flowchart and/or one or more blocks in the block diagram.

These computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart flow or flows and/or block diagram block or blocks.

The description of the present disclosure has been presented for purposes of illustration and description, and is not intended to be exhaustive or limited to the disclosure in the form disclosed. Many modifications and variations will be apparent to those skilled in this art. The embodiments were chosen and described in order to best explain the principles and the practical application of the disclosure, and to enable others of ordinary skill in the art to understand the disclosure so as to design various embodiments with various modifications suitable for the particular use.

1: A control method for displaying material, comprising:
extracting a user identification of a client from an access request sent by the client;
extracting a commodity material corresponding to the number of times of historical accesses associated with the user identification from a recommendation list associated with the user identification, wherein the commodity materials in the recommendation list are sorted according to the user's preference; and
delivering the extracted commodity material to the client for displaying in a page window.

2: The control method according to claim 1, further comprising, after extracting the user identification:
judging whether the access request is a first access request sent by the client according to the user identification;
generating the recommendation list associated with the user identification under the condition that the access request is the first access request sent by the client.

3: The control method according to claim 2, further comprising:
judging whether a time interval between the access request and a previous access request exceeds a preset interval threshold;
updating the recommendation list under the condition that the time interval exceeds a preset interval threshold;
clearing the number of times of the historical accesses.

4: The control method according to claim 1, wherein the extracting the commodity material comprises:
adding 1 to the number of times of historical accesses to obtain a list index;
extracting the commodity material corresponding to the list index from the recommendation list.

5: The control method according to claim 4, wherein
the recommendation list comprises multiple recommendation sub-lists, the page window comprises multiple page sub-windows, the recommendation sub-lists correspond to the page sub-windows one to one;
wherein the extracting the commodity material comprises:
extracting commodity materials from the recommendation sub-lists associated with the user identification.

6: The control method according to claim 5, further comprising, after extracting the commodity materials:
judging whether any two materials are similar according to the similarity between the two similar materials, wherein the two materials are similar under the condition that the similarity between the two materials is greater than a preset similarity threshold;
replacing one material of two similar materials with a next commodity material in the recommendation sub-list corresponding to the one material under the condition that the two materials are similar, to ensure that the extracted commodity materials are not similar.

7: The control method according to claim 1, further comprising:
updating the number of times of historical accesses, and delivering the updated number of times of historical accesses to the client.

8: The control method according to claim 7, further comprising, after updating the number of times of historical accesses:
judging whether the updated number of times of historical accesses is less than a preset times threshold;
clearing the number of times of historical accesses under the condition that the updated number of times of historical accesses is not less than a preset times threshold, and delivering the cleared number of times of historical accesses to the client.

9-16. (canceled)

17: A control device for displaying material, comprising:
a memory; and
a processor coupled to the memory, the processor configured to:
extract a user identification of a client from an access request sent by the client;
extract a commodity material corresponding to the number of times of historical accesses associated with the user identification from a recommendation list associated with the user identification, wherein the commodity materials in the recommendation list are sorted according to the user's preference; and
deliver the extracted commodity material to the client for displaying in a page window.

18: A control system for displaying material, comprising:
a control device for displaying material according to claim 17;
a client configured to send an access request to the control device, wherein the access request comprises a user identification, and configured to receive commodity material delivered by the control device, to display the commodity material in a page window.

19: The control system according to claim 18, wherein
the client is also configured to receive information of the number of times of historical accesses delivered by the control device as the current number of times of historical accesses.

20: A non-transitory computer readable storage medium, wherein the computer readable storage medium stores computer instructions which, when executed by a processor on a computing device, cause the computing device to:
extract a user identification of a client from an access request sent by the client;
extract a commodity material corresponding to the number of times of historical accesses associated with the user identification from a recommendation list associated with the user identification, wherein the commodity materials in the recommendation list are sorted according to the user's preference; and
deliver the extracted commodity material to the client for displaying in a page window.

21: The control device according to claim 17, the processor is configured to:
judge whether the access request is a first access request sent by the client according to the user identification after extracting the user identification;
generate the recommendation list associated with the user identification under the condition that the access request is the first access request sent by the client.

22: The control device according to claim 21, the processor is configured to:
judge whether a time interval between the access request and a previous access request exceeds a preset interval threshold;
update the recommendation list under the condition that the time interval exceeds a preset interval threshold;
clear the number of times of the historical accesses.

23: The control device according to claim 17, the processor is configured to:
add 1 to the number of times of historical accesses to obtain a list index;
extract the commodity material corresponding to the list index from the recommendation list.

24: The control device according to claim 23, wherein
the recommendation list comprises multiple recommendation sub-lists, the page window comprises multiple page sub-windows, the recommendation sub-lists corresponds to the page sub-windows one to one;
the processor is configured to:
extract commodity materials from the recommendation sub-lists associated with the user identification.

25: The control device according to claim 24, the processor is configured to:
judge whether any two materials are similar according to the similarity between the two similar materials after extracting the commodity materials, wherein the two materials are similar under the condition that the similarity between the two materials is greater than a preset similarity threshold;
replace one material of two similar materials with a next commodity material in the recommendation sub-list corresponding to the one material under the condition that the two materials are similar, to ensure that the extracted commodity materials are not similar.

26: The control device according to claim 17, the processor is configured to:
update the number of times of historical accesses, and
deliver the updated number of times of historical accesses to the client.

27: The control device according to claim 26, the processor is configured to:
judge whether the updated number of times of historical accesses is less than a preset times threshold after updating the number of times of historical accesses;
clear the number of times of historical accesses under the condition that the updated number of times of historical accesses is not less than a preset times threshold, and delivering the cleared number of times of historical accesses to the client.
